(19) United States
(12) Patent Application Publication
(10) Pub. No.: US 2009/0303410 A1
(43) Pub. Date: Dec. 10, 2009

(54) Display apparatus and back light unit to be used therefor

(75) Inventors: Seiji Murata, Fujisawa (JP); Satoshi Ouchi, Kamukura (JP)

Correspondence Address: Juan Carlos Marquez;REED SMITH LLP, Suite 1400, 3110 Fairview Park Drive, Falls Church, VA, 22042, US

(73) Assignee: Hitachi, Ltd.

(21) Appl. No.: 12/457,258

(22) Filed: Jun. 4, 2009

(30) Foreign Application Priority Data
Jun. 9, 2008 (JP) 2008-150057
Mar. 26, 2009 (JP) 2009-075375

(51) Int. Cl. G02F 1/13357; G02F 1/1333

(52) U.S. Cl. 349/58; 349/65

(57) ABSTRACT

A back light unit includes a light source unit combined with an optical waveguide having translucency to guide a light of light source in a direction of liquid crystal panel, and a chassis for holding or supporting the light source unit. The optical waveguide is formed in plate-like shape, a face opposing to the back face of liquid crystal panel is used as a light emitting surface, a face opposing to the chassis is used as a reflecting face for reflecting a light, one of a plurality of side faces adjacent to light emitting surface and reflecting face is used as a light incidence surface where a light from the light source is injected. The light source unit is arranged in multiple in a horizontal direction or a vertical direction of the liquid crystal panel, in the back face side of the liquid crystal panel.

### INCORPORATION BY REFERENCE

The present application claims priorities from Japanese applications JP2008-150057 filed on Jun. 9, 2008, JP2009-075375 filed on Mar. 26, 2009, the contents of which are hereby incorporated by reference into this application.

### BACKGROUND OF THE INVENTION

The present invention relates to a display apparatus provided with a back light unit for irradiating a light, for example, onto a liquid crystal panel.

In a display apparatus using a passive element such as, for example, liquid crystal panel as a display device, mainly the following two systems are known as a system of a back light unit for irradiating a light onto the liquid crystal panel. One is a side-light system for irradiating a light from either side or up and down end part of the liquid crystal panel, and for example, one described in JP-A-2008-103162 is known. The other is a direct backlight for irradiating a light from the back face of the liquid crystal panel, and for example, one described in JP-A-2008-103200 is known.

### SUMMARY OF THE INVENTION

In the side-light system, because a light source is arranged at the end of the view screen in a focused way, radiation or cooling of heat from the light source, control of illuminance of the light source, for example, in response to an image signal, and scale-up are more difficult as compared with the direct backlight. On the other hand, in the direct backlight, because the number of light sources to be used increases as compared with the side-light system, cost and power consumption increase. In addition, the direct backlight requires to increase distance from the light source to the liquid crystal panel (that is, distance in a thickness direction of the liquid crystal panel), in order to reduce luminance non-uniformity of image displayed on the liquid crystal panel, and is thus disadvantageous in producing a thinner type display apparatus.

The present invention has been proposed in view of the above conventional technological problems, and it is an object of the present invention to provide technology which is capable of making a thin-type display apparatus, with a larger screen, as well as enhancing heat radiation performance, performance of illuminance control of the light source and picture quality.

The present invention provides a plurality of light sources configured so as to emit a light in a direction parallel to the display face of the liquid crystal panel, and an optical waveguide including a light incidence surface installed respectively corresponding to a plurality of the above light sources and a light emitting surface, which opposes to the back face of the above display panel and emits a light injected to said light incidence surface to the above liquid crystal panel side, wherein sets of the light source and the light incidence surface of the optical waveguide are arranged in multiple in a horizontal or a vertical direction of the above liquid crystal panel, in the back face side of the display region of the above display panel.

In addition, the back light unit relevant to the present invention includes a light source unit having in combination with a light source for emitting a light, and an optical waveguide having translucency to guide a light of relevant light source in a direction of the above liquid crystal panel, and a chassis for holding or supporting said light source unit, wherein the above optical waveguide is formed plate-like, as well as, a face opposing to the back face of the above liquid crystal panel is used as a light emitting surface, and a face opposing to the above chassis is used as a reflecting face for reflecting a light, and one of a plurality of side faces adjacent to the above light emitting-surface and the above reflecting face is used as the light incidence surface, where light from the above light source is injected, and the above light source unit is arranged in multiple, in a horizontal direction or a vertical direction of the above liquid crystal panel, in the back face side of the above liquid crystal panel.

A plurality of the light source units may be arranged, so that the above optical waveguide of one of the above light source units and the light source of other light source unit overlap, in a direction orthogonal to the display face of the above liquid crystal panel. In this case, such arrangement is preferable that the light source of the other light source unit is positioned at the back face side of the reflecting face of the optical waveguide in one of the light source units.

According to the present invention, it is capable of making a thin-type display apparatus, with a larger screen, as well as enhancing heat radiation performance, performance of illuminance control of the light source and picture quality.

Other objects, features and advantages of the invention will become apparent from the following description of the embodiments of the invention taken in conjunction with the accompanying drawings.

### BRIEF DESCRIPTION OF THE DRAWINGS

FIG. 1A and FIG. 1B are drawings showing a first embodiment of the present invention.

FIG. 2 is a drawing showing a second embodiment of the present invention.

FIG. 3 is a drawing showing a modification embodiment of the second embodiment of the present invention.

FIG. 4 is a drawing showing a modification embodiment of the second embodiment of the present invention.

FIG. 5A and FIG. 5B are drawings showing third embodiments of the present invention.

FIG. 6 is a drawing showing a fourth embodiment of the present invention.

FIG. 7A to FIG. 7D are drawings showing fifth embodiments of the present invention.

FIGS. 8A to 8C are drawings showing one embodiment of a light source 1.

FIG. 9 is a drawing showing optical function of an optical waveguide 2.

FIG. 10 is a drawing showing a sixth embodiment of the present invention.

FIG. 11A and FIG. 11B are drawings showing seventh embodiments of the present invention.

FIG. 12A and FIG. 12B are drawings showing eighth embodiments of the present invention.

FIG. 13 is a drawing showing a ninth embodiment of the present invention.

### DESCRIPTION OF THE EMBODIMENTS

Explanation will be given below on embodiments of the present invention. The present embodiments are those characterized by having a configuration of a back light, so as to supplement each other the problems of the above side-light system and direct backlight, that is, the present embodiments are those characterized by a light source configuration used in the side-light system, namely, a configuration arranging in multiple the light source configuration such that a light from the light source is emitted in a direction nearly parallel to the display face of the liquid crystal panel, and this is guided in a direction of the liquid crystal panel by folding in nearly right angle by a optical waveguide on a flat plate having transmission property, at the back face (just-beneath) of the display region of the liquid crystal panel. Explanation will be given below in detail thereon with reference to attached drawings.

### Embodiment 1

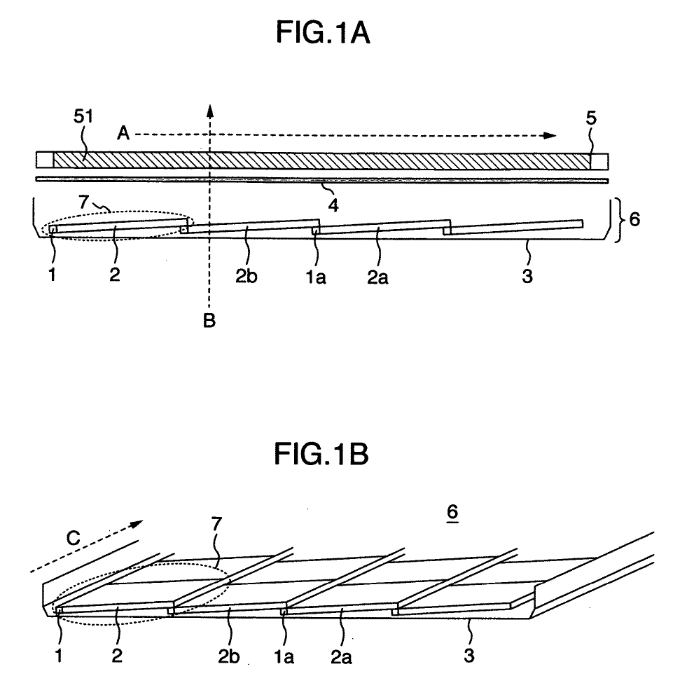

FIGS. 1A and 1B shows an example of a configuration of an image display apparatus relevant to a first embodiment of the present invention. FIG. 1A is a cross-sectional view of a horizontal direction of the liquid crystal panel 5, of a liquid crystal image display apparatus including the liquid crystal panel 5 and the back light unit 6, and also FIG. 1B shows a perspective view of such a back light unit 6. In this drawing, the arrow mark A is a direction parallel to the display face of the liquid crystal panel 5, shows a horizontal direction of the liquid crystal panel 5. In addition, the arrow mark B is a direction orthogonal to the display face of the liquid crystal panel 5, and the arrow mark C is a direction parallel to the display face of the liquid crystal panel 5, shows a vertical direction of the liquid crystal panel 5.

The image display apparatus relevant to the present embodiment, as shown in FIG. 1A, is provided with the liquid crystal panel 5 as a passive display device, and the back light unit 6 for irradiating a light onto this liquid crystal panel 5, and an optical sheet 4 arranged between the liquid crystal panel 5 and the back light unit 6, for diffusing a light of the back light unit 6.

The liquid crystal panel 5 may have a color filter, or may be mono-chromatic, and may be an IPS system or a VA system. The image display apparatus relevant to the present embodiment, although not shown, shall be one configured by including a signal control circuit, a power source circuit, a panel drive circuit, a housing for storing these elements, and the like. In addition, the optical sheet 4 is schematically drawn as one sheet in FIG. 1A, however, it is configured practically by combination of any of a diffusion sheet, a prism sheet, a diffusion plate, a reflecting film with polarized light selectivity and the like. These sheets have effect to enhance brightness uniformity by transmission and diffusion of light reflected again from the back light unit 6, because they reflect a part of light emitted from the light source 1 and reflect a light to the back light unit 6 side.

The back light unit 6 relevant to the present embodiment, as shown in FIG. 1A, contains a light source unit 7 having in combination of a light source 1 including a plurality of light emitting devices such as, for example, a light emitting diode (LED), and a optical waveguide 2, in which a light emitted in the arrow mark A direction (that is a horizontal direction of the liquid crystal panel) from the relevant light source 1 is injected and this light is guided to the liquid crystal panel 5 arranged at the upper part of the back light unit 6 by folding this light in the arrow mark B direction (that is a direction orthogonal to the display face of the liquid crystal panel). This light source unit 7 is arranged in multiple, as shown in the drawing, in the arrow A direction, that is, in a horizontal direction of the liquid crystal panel 5, and these light source units 7 are stored inside a box-type chassis 3 configured by a metal such as, for example, aluminum, and held or supported inside the chassis 3.

In the present embodiment, as will be described later, in arrangement of the light source unit 7, the light source 1 of the relevant certain light source unit 7 and the optical waveguide 2 of other light source unit 7 are overlapped in the arrow mark B direction, so that the light source 1 of a certain light source unit 7 is positioned at the back face side of the optical waveguide 2 in other light source unit 7 adjacent to the relevant certain light source unit 7. In addition, each of the light source units 7, in a horizontal direction of the liquid crystal panel 5 respectively, is arranged in an inclined state, so that the light source 1 is positioned at the more chassis side than the end part of the opposite side of the light source 1 side of the optical waveguide 2. In this way, the above overlap is made possible.

In the present embodiment, the light source unit 7 including the above light source 1 has such a configuration to be arranged also at the back face (just-beneath) of the display region 51 of the liquid crystal panel 5 shown by the hatching in the drawing, and is one utilizing a light source configuration of the side-light system, which guides a light in a parallel direction to the display face of the liquid crystal panel 5 in a direction of the liquid crystal panel 5, as the direct backlight. It should be noted here that the display region 51 is a region where image is displayed in the liquid crystal panel 5, and is a region excluding a driver for driving the liquid crystal panel, a shift register or various electrodes and a connector.

Here, in this embodiment, the light source 1 is described as one configured by LED, as described above, however, it may be a point light source such as a laser light source, and also a fluorescent tube such as CCFL, EEFL. In the case where the light source 1 is configured by the fluorescent tube, the number of the light source 1 per one light source unit 1 may be one. In addition, such a light source unit may also be used that a point light source such as a laser light source is arranged in multiple, in linear light source shape. The light source 1 may have a configuration, where a set of light emitting devices of, for example, RGB three colors is arranged in multiple, or a set of other color than RGB (for example, blue, yellow) may also be used. In the case where a light emitting device of a plurality of colors is used, optical parts for color mixing of light from the light emitting devices of these different colors may be provided at the light source 1. In addition, it may be a configuration where a light emitting device of a single color (for example, white color) is provided in multiple.

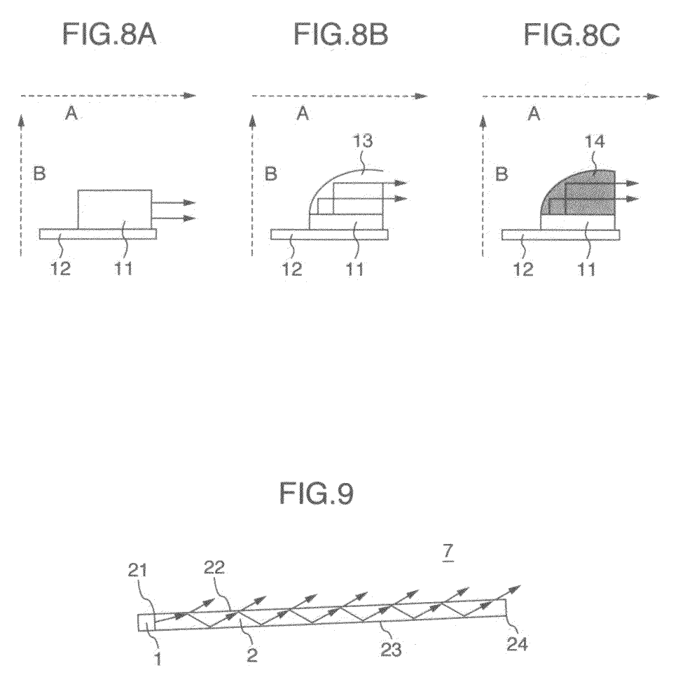

Explanation will be given on one example of this light source 1 with reference to FIG. 8, with an example where the light emitting device is a semiconductor light emitting device such as, for example, LED. FIG. 8 shows the cross-section of a horizontal direction of the liquid crystal panel 5 of the light source 1 to be used in the light source unit 7, and FIG. 8A shows one example of the light source 1. The light source 1 of this embodiment is configured by a light emitting device 11 which is configured or arranged so as to irradiate a light in a nearly parallel direction to the arrow mark A direction, that is, a horizontal direction of the liquid crystal panel 5, and a substrate 12 for supplying a signal for driving to the light emitting device 11. Although not shown, the substrate 12 may be mounted with a connector for connecting a control circuit to control lighting or illuminance of the light emitting device 11, or a driver for driving the light source. In addition, the substrate 12 may be prepared by AGSP, a lead frame, a thin-type substrate or the like, and a material thereof may be selected depending on heat radiation property, arrangement condition or the like.

In addition, the light source 1, as shown in FIG. 8B, may be provided a reflector 13, which changes a light emission direction of the light emitting device 11 in the arrow mark B direction (a direction orthogonal to the display face of the liquid crystal panel) of FIG. 1, and reflects the light in the arrow mark A direction. Shape of the reflector 13 may be considered a parabolic face, an ellipse face, a plane, a free curved face or the like, however, other shape may also be used. Optical characteristics of the reflector 13 may be composed by any of diffusion reflection, mirror reflection, and a combination of both. In addition, the reflector 13 may also be configured by utilization of a part of the optical waveguide 2. For example, the end part of the optical waveguide 2 may be given a function similar to the reflector 13, by fabrication of printing, patterning, lens molding or the like, for diffusion reflection and mirror reflection. In addition, still more, as shown in FIG. 8C, a solid prism 14, which refracts or reflects a light of the arrow mark B direction from the light emitting device 11 and leads to the arrow mark A direction, may also be provided. The prism 14 is one for adjusting an emission direction of the light source by utilization of interior reflection, and it is desirable that a material thereof is configured by a transparent material such as acrylic resin, PMMA, ZEONOR (registered trade name), BMC, OZ, polycarbonate, silicon, glass.

In the case where illuminance (intensity of light emitted from the light source 1) of the above light source 1 is controlled by using, for example, brightness information of an image signal via the substrate 12, it may be controlled by each light source unit 7 with the light source of each optical unit 7, as a unit. In the case where the light source 1 of each light source unit 7 is configured by a plurality of light emitting devices, control may also be performed by each of the light emitting devices, and in the case where a plurality of light emitting device sets with different colors are provided, control may also be performed by each of the light emitting device sets.

In the case where control is performed by each light source unit 7, with a light source of each optical unit 7, as a unit, brightness or color of a displayed image on the liquid crystal panel 5 can be controlled locally. As a result, contrast or color purity of the relevant displayed image can be improved. The more number of the light source units 7 is capable of providing the finer control, for example, as shown in FIG. 1A, in the case where four light source units 7 are arranged in a horizontal direction of the liquid crystal panel 5, the display region 51 of the liquid crystal panels 5 is divided to four regions corresponding to each of the light source units 7, and brightness or color can be controlled by each of the divided regions. In addition, as shown in FIG. 1B, if the light source unit 7 is arranged in multiple (for example, four) in the arrow mark C direction (a vertical direction of the liquid crystal panel 5) as well, the display region 51 is divided to 16 (sixteen) regions and individual control of brightness or color of the displayed image becomes possible every 16 (sixteen) divided regions. Of course, the number (division number of the display region) of the light source units 7 is not limited thereto, and for example, the divided regions may be 25 (twenty-five), by 5 (five) arrangements in a horizontal direction and 5 (five) arrangements in a vertical direction, or the divided regions may be 40 (forty) by 8 (eight) arrangements in a horizontal direction and 5 (five) arrangements in a vertical direction. It is natural that the light source units 7 may be arranged in multiple only in a vertical direction of the liquid crystal panel 5. Numbers of the light source units 7 in a horizontal direction and in a vertical direction may be the same, or may be different. As described above, the more number of the light source units 7 is capable of providing the finer control, however, too many number increases parts number or cost in a large extent, and thus it is desirable to set the suitable number, in response to the size of the liquid crystal panel 5.

In addition, the optical waveguide 2 in the present embodiment is formed, for example, as shown in a perspective view of FIG. 1B, to have nearly rectangular and flat plate shape when viewed from the arrow mark A direction, and is used as a light incidence surface where light from the light source 1 is injected to the one side face. The optical waveguide 2 is configured as a solid body using a transparent material such as, for example, acrylic resin, PMMA, ZEONOR (registered trade name), BMC, OZ, polycarbonate, silicon, glass, having a light transmission property. The optical waveguide 2 may not be a solid body and may be a hollow body, and may be, for example, a configuration to have a space surrounded by sheets having certain reflection characteristics.

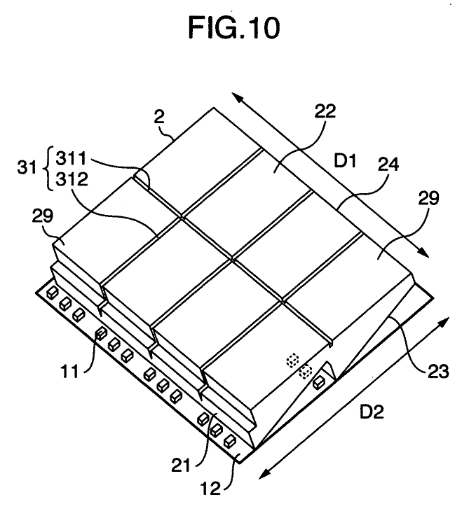

Here, explanation is given on optical action of the optical waveguide 2 with reference to FIG. 9. FIG. 9 shows appearance of light passing through the inside of the optical waveguide 2 in the optical unit 7. As shown in the drawing, the optical waveguide 2 has a light incidence surface 21 where light from the light source 1 is injected, which is one side face of the optical waveguide 2; a reflecting face 23 facing to the inner face of the chassis 3 for reflecting a light injected to this light incidence surface 21; a light emitting surface 22 facing to the back face of the liquid crystal panel 5 for emitting a light reflected at this reflecting face 23 and a light from the light incidence surface 21 toward the liquid crystal panel 5; and an end face 24 (hereafter may also be referred to as an end part), which is the side face opposing to the light incidence surface 21. Each of the faces may be configured by a curved face or a plurality of planes.

Light emitted from the light source 1 is guided to the inside of the optical waveguide 2 via the light incidence surface 21, and a part of light reached the light emitting surface 22 transmits the light emitting surface 22, and a part thereof is reflected to the inside of the optical waveguide 2 by the light emitting surface 22. Light reflected at the light emitting surface 22 is reflected at a reflecting face 23, and a part thereof is emitted again from the light emitting surface 22. As a result, by nearly uniform emission of light from the light emitting surface of a light guiding unit 2, brightness uniformity can be enhanced nearly throughout the whole faces of the light emitting surface 22 of the optical waveguide 2. Here, in order to enhance brightness uniformity much more, there may be provided, at the front face or the inner face of the optical waveguide 2, optical irregularity to adjust transmission property, reflection property, diffusion property and light distribution, or a spatial patterning to control transmittance and reflectance. Such optical irregularity or patterns can be prepared, for example, by forming shape to a mold, in advance, corresponding to the irregularity or patterns.

Still more, the optical waveguide 2 may be combined with an optical sheet such as a diffusion reflecting sheet, a mirror, a diffusion sheet, a prism sheet, a diffusion plate, a reflecting film with polarized light selectivity, or the above optical characteristics may be attained by vacuum deposition or printing. In addition, although not shown, a dowel, a hole or a groove for positioning and fixing may be provided at the optical waveguide 2 or the chassis 3, for positioning of the optical waveguide 2 and the chassis 3. The chassis 3 is configured by a material of aluminum, steel, a titanium alloy or the like, and is molded, for example, by pressing or skiving or the like. In addition, the chassis 3 may be configured by not only a metal but also a resin such as acrylic resin, PMMA, ZEONOR (registered trade name), BMC, OZ, polycarbonate, silicon.

In the case where the back light unit is configured by only one light source unit 7 (one set of the light source unit 1 and the optical waveguide 2), progress of large sizing makes difficult to attain brightness uniformity. Therefore, it is considered a method for configuring the back light unit by combination of a plurality of optical waveguides having high brightness uniformity. However, as for brightness distribution of the light source unit, because brightness at the vicinity of the light source 1 tends to become high, use of a plurality of light source units generates brightness difference at the boundary of mutual light source units, and thus brightness uniformity of the back light unit results is deteriorated.

Therefore, in the present embodiment, as shown in FIG. 1A, light emitted directly from the light source 1a to the light emitting surface of the optical waveguide 2a is blocked by the optical waveguide 2b, by arrangement of the light source 1a at the light incidence surface of the optical waveguide 2a of a certain light source unit 7, and by arrangement of the light source 1a at the lower part than the reflecting face of the optical waveguide 2b of other light source unit 7, that is, between the reflecting face of the optical waveguide 2b and the inner face of the chassis 3. As a result, increase in brightness at the vicinity of the light source 1a on the optical waveguide 2a is suppressed. Therefore, by suppression of brightness difference at the boundary part of a plurality of the optical waveguides 2, it becomes possible to provide a large size back light unit having high brightness uniformity.

In this way, according to the present embodiment, because a light source configuration (the light source unit 7) of the side-light system is used as the back light, it is not necessary to increase a distance between the light source and the liquid crystal panel to reduces luminance non-uniformity as in the direct backlight, and is thus advantageous in making a thin type back light unit and an image display apparatus as compared with the direct backlight. In addition, it is possible to irradiate the uniformed light over the whole display region of the liquid crystal panel, without using a plurality of light sources as in the direct backlight (that is, by less light sources than the direct backlight), and to reduce luminance non-uniformity and to enhance picture quality of the displayed image. In addition, in the conventional side-light system, the light source was arranged at both ends or one end of either side (or up/down) of the display region of the liquid crystal panel, and light was irradiated from exterior of the display region to the liquid crystal panel, therefore, brightness decreases at a part apart from the light source, for example, the center part of the liquid crystal panel, in the case where the light source was arranged at both ends of either side of the liquid crystal panel, and other end part of the liquid crystal panel, in the case where it was arranged at one end of the liquid crystal panel. However, in the present embodiment, because the above light source unit is also arranged at the back face side of the display region of the liquid crystal panel, such decrease in brightness can be reduced and image with high brightness can be displayed.

Still more, because the light source 1 is also arranged at a part corresponding to the display region 51 of the back light unit, density of heat generation from the light source 1 becomes small, and a back light unit with high heat radiation performance can be provided. And, by combination of the above back light unit 6 and the liquid crystal panel 5, an image display apparatus with high brightness uniformity can be provided.

### Embodiment 2

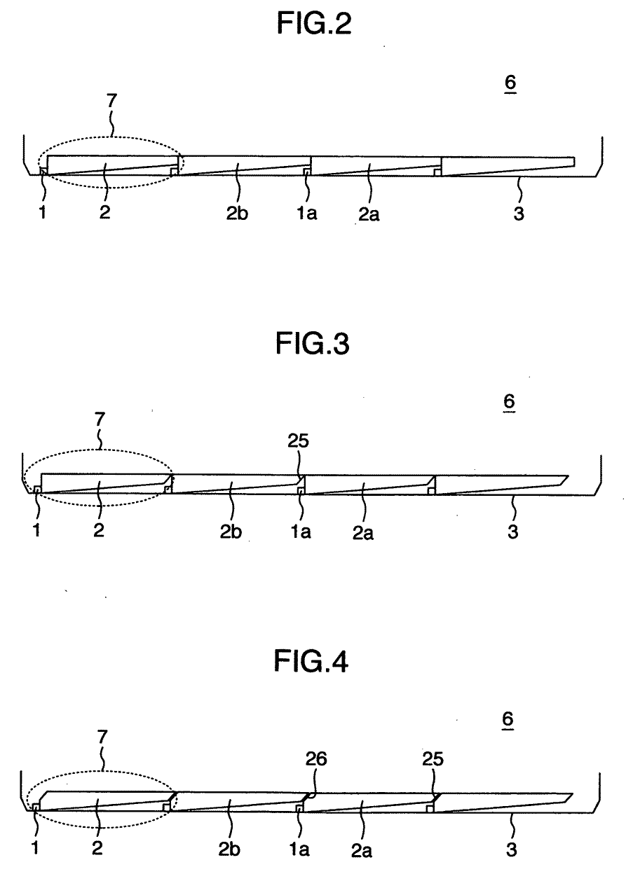

Explanation will be given below on a second embodiment of the present invention with reference to FIGS. 2 to 4.

In the above first embodiment, each of the light source units 7 was arranged in an inclined state, however, in the second embodiment shown in FIG. 2, each of the light source units 7 is arranged, so that the light emitting surfaces of a plurality of optical waveguides 2 are aligned on nearly the same plane. Also, in the present embodiment, to make possible the above overlap, that is, so that the light source 1a of a certain light source unit 7 can be arranged at the part lower than the reflecting face of the optical waveguide 2b of other light source unit 7, such shape is taken that the reflecting face of the optical waveguide 2 of each of the light source units 7 is inclined against the light emitting surface or the main plane of the chassis 3, and thickness of each of the optical waveguides 2 gradually decreases from the light incidence surface toward the end face. In this way, space that is capable of storing or arranging the light source 1 is formed between the lower part of the reflecting face at the vicinity of the end face (end part) of each of the optical waveguides 2 and the inner face of the chassis 3. In this case, by arrangement of light source 1 at such a position that light is injected to the lower side (chassis 3 side) of the light incidence surface of the optical waveguide 2, the above-described overlap becomes easier.

As a modification embodiment of the second embodiment, for example, as shown in FIG. 3, the end part of each of the optical waveguides 2 may be inclined to form an end part inclined face 25. In this way, because light reached the end part of the optical waveguide 2 can be reflected by the end part inclined face 25 and emitted to the light emitting surface, utilization efficiency of light can be enhanced, as well as brightness of the end part of the optical waveguide 2 can be increased, and brightness difference from the light source 1 can be reduced. Therefore, by a configuration of such a modification embodiment, mutual brightness uniformity in the light source units 7 can be enhanced.

In addition, as in other modification embodiment shown in FIG. 4, a part of other than light injected from the light source 1 of the light incidence surface of each of the optical waveguides 2 may be formed as an injecting inclined face 26 in response to shape of the end part inclined face 25. In this way, boundary of the optical waveguides 2a and 2b is configured in parallel, which makes assembly easy and provides effect to enhance productivity.

By such a configuration of the present embodiment, distance between the irradiation face (that is the back face of the liquid crystal panel 5) of the back light unit 6 and emitting face of the optical waveguide 2 is maintained constant over nearly the whole faces of the display region 51, which makes possible to enhance brightness uniformity of the back light unit as a whole. Therefore, as compared with the embodiment 1, it is possible to configure a large-size back light unit with higher brightness uniformity of the displayed image.

In addition, emission light may be reflected at the end part of the optical waveguide 2, which is arranged at the upper part of the light source 1, and may be injected to the optical waveguide 2. In order to attain this, mirror deposition, printing, patterning, lens or the like may be formed at the end part of the optical waveguide 2, that is, the end part inclined face 25. As shape of the face, an eclipse face, a parabolic face, a free curved-face, a polygon or the like is used. By the above structure, light distribution from the light source 1 can be adjusted, and a back light unit with further higher brightness uniformity and higher quality can be attained.

### Embodiment 3

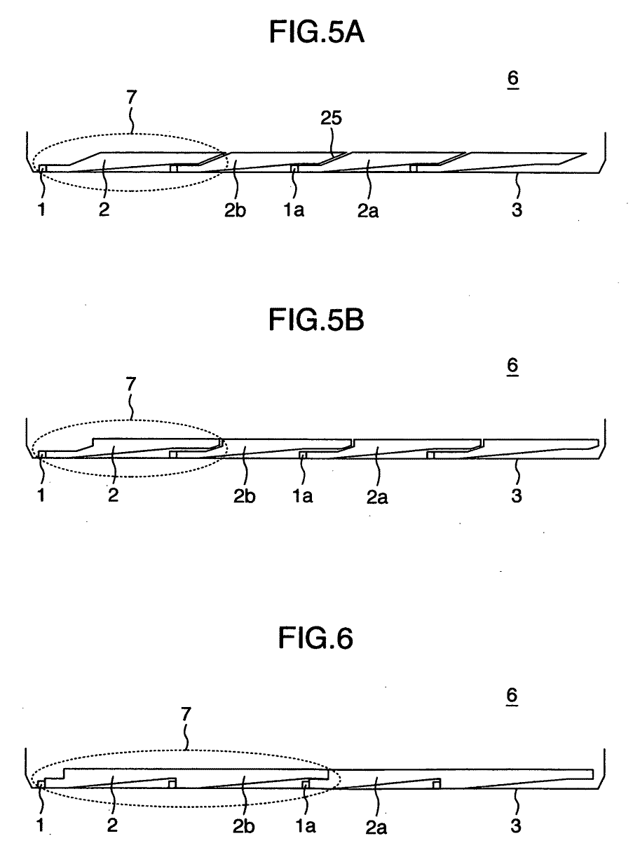

Explanation will be given below on a third embodiment of the present invention with reference to FIG. 5.

In this embodiment, as shown in FIG. 5A, the end part inclined face 25 is provided at the end part of the optical waveguide 2, as well as all of the reflecting faces are made parallel to the light emitting surface at the vicinity of the end part inclined face 25, without inclining at the light emitting surface. Still more, a step having shape corresponding to shape of the end part including the end part inclined face 25 is provided at the vicinity of the light incidence surface of the optical waveguide 2, so as to provide a shape to put on the end part of the adjacent optical waveguides 2. For example, at the vicinity of the injecting face of the optical waveguide 2a, a step having shape, which is capable of putting on a part of the end part of the optical waveguide 2b, is formed, which makes positioning of a plurality of the optical waveguides 2 easy. Therefore, because of easy assembly and enhancing effect of productivity, it is possible to provide a back light unit having reduced production cost.

In addition, as shown by a modification embodiment in FIG. 5B, chamfering may be performed so that the tip part of the optical waveguide 2 is not sharp. By this chamfering, destruction such as cracking can be prevented and durability is increased. In addition, although not shown, a curved face may be formed at the tip part of the optical waveguide 2.

### Embodiment 4

Explanation will be given below on a fourth embodiment of the present invention with reference to FIG. 6.

The present embodiment is one, where an optical unit having one optical waveguide and two light sources, is configured by connection of two light source units together for integration. The optical waveguide like this can be produced by a production method such as, for example, a one-piece molding method. Therefore, installation to the chassis 3 becomes easy, and the number of assembling steps can be reduced. Therefore, it is possible to provide a back light unit having reduced production cost. In addition, by making the reflecting face at the vicinity of the light incidence surface of the optical waveguide 2 parallel to the inner face of the chassis 3, positioning or installment of the chassis 3 becomes easy, and still more assembling performance is enhanced.

### Embodiment 5

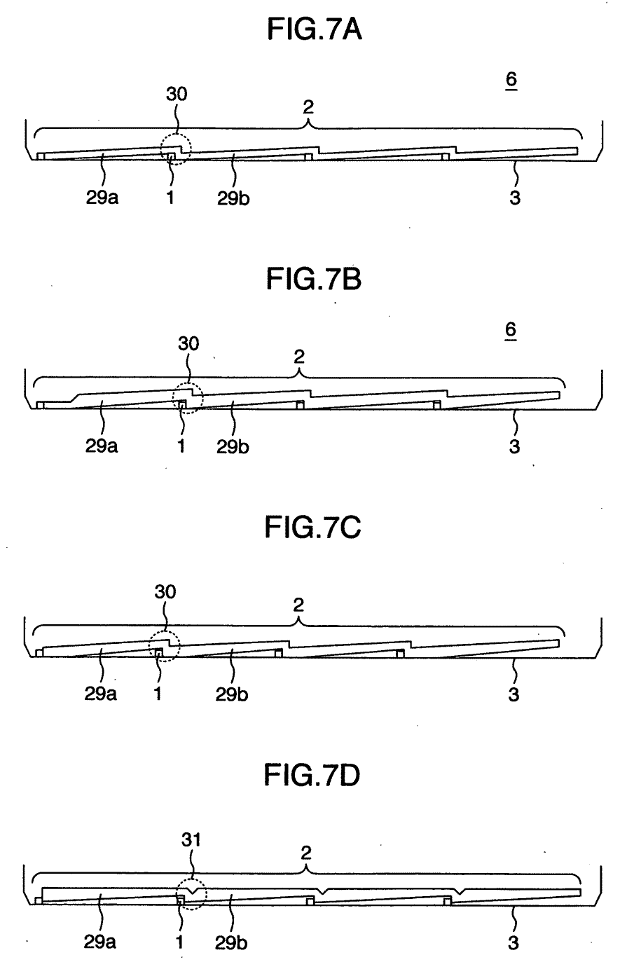

Explanation will be given below on a fifth embodiment of the present invention with reference to FIG. 7.

The present embodiment is characterized in that, as shown in FIG. 7A, by installment of a plurality of steps 30 arranged in a horizontal direction of the optical waveguide, a plurality of optical waveguide units 29a and 29b are formed at one sheet of the optical waveguide, and still more, by the step 30, a face formed at the chassis 3 side was made as a light incidence surface where light from the light source 1 is injected. Here, distance between each of the steps shall be the same. That is, in the present embodiment, the light source unit is configured by installment of a plurality of optical waveguide units and a plurality of light sources corresponding to each of a plurality of optical waveguide units, at one optical waveguide.

In the first to the fourth embodiments, because the optical waveguide of a separate substance is arranged in multiple, a narrow mutual clearance, or interface is present between the optical waveguides. This interface generates refraction or total internal reflection, and gives optical influence. In the present embodiment, because the one-piece molded optical waveguide 2 is used, the above interface is not present, and optical influence caused by such an interface can be reduced. In addition, by installment of a plurality of the steps 30 at the optical waveguide, optical function of a plurality of optical waveguides, that is, the optical waveguide units 29a and 29b, can be given to one optical waveguide. And, installment of the step 30 provides interface between the step part of the optical waveguide 2 and air, and the nearly same optical characteristics as one arranged with a plurality of optical waveguides of the separate substances can be created, therefore a back light unit having suppressed change of brightness distribution by one-piece molding of the optical waveguide, and having high brightness uniformity, can be attained. In this embodiment, the above-described divided region shall be specified by the step 30.

FIG. 7B is a modification embodiment of the fifth embodiment, and thickness of the optical waveguide unit 29 is gradually decreased from a certain step 30 to an adjacent step. Still more, by installment of taper at the vicinity of the light incidence surface positioned nearest to the end part of the chassis 3 of the optical waveguide 2, control of brightness uniformity is made easy. As a result, brightness uniformity is maintained and designing for thinning becomes easy. In addition, as shown in FIG. 7C, by installment of a flat part at the bottom face corresponding to the step 30 formed between the optical waveguide units 29, arrangement to the chassis is made easy. As a result, assembling performance is improved, and it becomes possible to suppress assembling cost of the back light unit.

FIG. 7D is a modification embodiment of the fifth embodiment, and provides a configuration where a groove 31 is installed at the vicinity of the light source 1 of the light emitting surface of the optical waveguide 2. This groove 31 is one for dividing or partitioning the optical waveguide 2 to a plurality of the optical waveguide units 29a and 29b, and has partial light blocking function or light limiting function so as not to partially block injection of light from a first optical waveguide unit 29a to an adjacent second optical waveguide unit 29b. In this way, emission light of each of a plurality of the optical waveguide units 29a and 29b can be suppressed so as not to leak from the inside of a desired region, which each of a plurality of the optical waveguide units bears. As a result, performing of control of brightness or color by each divided region, that is, brightness control of the desired region in so-called area control becomes easy, and a back light unit, which is capable of providing image with high contrast and high quality, can be attained.

The above groove 31 may be a V-character, a U-character, a curved face or a slit. In addition, a direction for cutting the slit may be not only a vertical direction of the liquid crystal panel 5 but also a horizontal direction thereof.

The bottom face of each of the optical waveguide units 29 may be inclined against the chassis 3 or the substrate, and the bottom face at the vicinity of the light incidence surface may be set parallel to the chassis 3 or the substrate. By taking a configuration in this way, because the bottom face at the vicinity of the light injecting part is nearly horizontal relation to the face of the chassis 3, incident light from the light source is made uniform once at the vicinity of the light source at the reflecting face, which is nearly horizontal against the chassis 3. Still more, light uniformed in this way can be made to have brightness uniformity in the light emitting surface, by the reflecting face having inclination against the chassis 3. Still more, because the optical waveguide 2 is one-piece molded, the number of installation steps can be reduced, and production cost can be reduced. The one-piece molded optical waveguide 2 may be used in multiple, or as only one sheet.

In this fifth embodiment, the number of installation steps to the chassis 3 is reduced by integrating partially or totally the optical waveguide 2, and improvement of production steps is intended. This one-piece molded optical waveguide 2 may be prepared by injection molding using a mold having a size corresponding to the size of the back light unit, or may be prepared by connecting mutually a plurality of optical waveguides with adhesives having refractive index nearly the same as that of a material of the relevant optical waveguide 2. In this way, the back light unit relevant to the present embodiment is capable of providing a thin-type back light unit with good productivity, which is enabling to control brightness locally.

In addition, in the present embodiment, for example, as shown in FIG. 8A, it is preferable to use a light emitting device 11, where light distribution has a peak in a direction nearly parallel to the face of the substrate 12 or the liquid crystal panel 5. As such a light emitting device, for example, what is called a side-view type LED, which emits a light in a direction parallel to the electrode face of an LED, is used. Such a light emitting device will be referred to as “a side-view type light emitting device” hereafter. And, as in the present embodiment, by using the side-view type light emitting device as a light source, because light from the light source is capable of increasing a light injecting vertically against the light incidence surface (that is incident angle is small), amount of incident light to the light incidence surface of the optical waveguide increases, which is capable of enhancing utilization efficiency of light from the light source. In the present embodiment, the light emitting device 11 is mounted directly on the substrate 12 forming plate-like shape, and the optical waveguide is arranged and fixed thereon.

Still more, by using the side-view type light emitting device, light injected to the light incidence surface is capable of decreasing the amount of light going directly toward the surface of the light emitting surface of the optical waveguide 2. This light going directly toward the surface of the light emitting surface of the optical waveguide enhances brightness at the vicinity of the light emitting device 11, in brightness distribution on the light emitting surface, and causes to deteriorate brightness uniformity. Therefore, use of the side-view type light emitting device has effect to improve brightness uniformity.

In addition, still more, because the side-view type light emitting device has, as described above, a peak of light distribution in a direction nearly parallel to the face of the substrate 12 or the liquid crystal panel, the substrate 12, where the light source 11 is mounted, can be arranged nearly parallel to the chassis 3 and the liquid crystal panel. In the case where a top-view type LED (such a type of an LED that emits light in a vertical direction against the electrode face of the LED) is used, it is necessary to give structural fabrication on the substrate 12, so as to make a direction of the light emission peak parallel to the face of the substrate 12 or the liquid crystal panel. Such fabrication is, to fold or bend the relevant substrate 12, so as to make, for example, the face of the substrate 12, where the light emitting device 11 is mounted, in a vertical direction to the chassis. However, because use of the side-view type light emitting device changes the direction of the light emission peak of the light emitting device 11, the above fabrication to the substrate 12 is not necessary, and the substrate 12 can be configured in a nearly plane state. Therefore, fabrication cost of the substrate 12 can be suppressed. Still more, close adherence of the substrate 12 and the chassis in wide area is also possible. That is, by configuring a material of the substrate 12 by utilization of a material such as copper and an AGSP (Advanced Grade Solid-bump Process) with low thermal resistance, and subjecting this to face contact with the chassis or the like, it is capable of also improving heat radiation and cooling ability. According to such a configuration, temperature increase of the light emitting device 11 caused by light emission can be suppressed and decrease in efficiency caused by temperature increase of the light emitting device 11 can be prevented, and thus a highly efficient back light unit can be provided. Between the substrate 12 and the chassis, in order to secure close adhesion in wide area, for example, grease or the like having good thermal conductivity may be intervened. In addition, in order to increase cooling efficiency further, a fin may be installed at the substrate 12.

Explanation was given, in the above embodiment, on the case of using the side-view type light emitting device, shown in FIG. 8A, as the light source unit 11, however, alternatively it is possible to use also, for example, the top-view type light emitting device (a type of an LED which emits light in a vertical direction against the electrode face of the LED). In this case, it is preferable that, direction of light from the top-view type light emitting device is folded in right angle, so that light distribution has a peak in a direction nearly parallel against the face of the substrate 12 or the liquid crystal panel, by installment of a reflecting mirror 13 or a prism 14 or the like, for example, as shown in FIGS. 8B and 8C, at the top-view type LED. In this way, almost similar effect can be obtained, as in the case where the side-view type light emitting device is used, without folding the substrate 12

### Embodiment 6

A specific example of the embodiment of the above FIG. 7D will be shown in FIG. 10, and also explanation will be given below on this, as a sixth embodiment of the present invention. FIG. 10 shows a part of the optical waveguide 2, which is obtained by one-piece molding of a plurality of the optical waveguide units 29 shown in FIG. 7D, and the same codes are given to the same elements as various elements explained in the embodiments previously. In this embodiment, eight optical waveguide units 29 are present, however, for simplification of illustration, code 29 is given only to a optical waveguide unit positioned at the both of either side ends in FIG. 10. Similarly, code 11 is given only to one light emitting device. In addition, in this embodiment, each three light emitting devices 11 are installed to each optical waveguide unit 29, however, it is not limited thereto naturally. This light emitting device 11 is, for example, the side-view type light emitting device, as shown in FIG. 8A, and a white color LED may be used as this light emitting device, or a plurality of sets may be used, provided that three LEDs, each emitting light of three colors of RGB, are one set. Still more, an LED emitting light of three colors of RGB and an LED emitting light of other color (for example, yellow or white color) may be used in combination. Of course, a light emitting device configured as shown in FIGS. 8B and 8C may also be used. These light emitting devices 11, in the present embodiment, are mounted linearly on the substrate 12 on one sheet of a plate, along the light incidence surface 21 at the optical waveguide 2.

In addition, the direction D1 in the drawing corresponds to the depth direction of the paper face of FIG. 7D, and corresponds to the arrangement direction of a plurality of the light emitting devices 11. On the other hand, the direction D2 corresponds to the either side direction of the paper face of FIG. 7D, and corresponds to the light emission peak direction of the light emitting device 11, that is, corresponds to the light emission direction. It should be noted here that the direction D1 is set to correspond to the vertical direction of the liquid crystal panel 5, and the direction D2 is set to correspond to the horizontal direction of the liquid crystal panel 5, however, the reversed response may be allowed.

In the present embodiment, as shown in FIG. 10, the groove 31 is installed at the light emitting surface 22 of the optical waveguide 2, and by this groove 31, the optical waveguide 2 is divided or partitioned to eight in the horizontal direction and the vertical direction of the liquid crystal panel 5, to form the eight optical waveguide units 29. That is, the groove 31 is one for determining boundary between the light guide units. This groove 31 includes a groove 311 which is parallel to the direction D1, and a groove 312 which is parallel to the direction D2, and each of the grooves has function as light regulation unit for limiting the light progressing from a certain optical waveguide unit 29 to a deferent each optical waveguide unit 29, by partially blocking. Hereafter, this groove may be called a light regulation unit for convenience. In addition, the reflecting face 23 of the bottom face of the optical waveguide 2 may be inclined against the chassis.

In a configuration of the present embodiment, by division or partition of the light emitting surface 22 of the optical waveguide 2 in multiple by the groove 31, and by light emission control of the light emitting device 11, corresponding to contents of image, brightness (and/or color of light) by each region (region on the light emitting surface 22 of the optical waveguide unit 29) can be adjusted. For example, in the case where image of the moon shining in a dark night is displayed, such a control is possible that light emission intensity of the light emitting device 11 corresponding to a region of the dark night (optical waveguide unit 29) is reduced or extinguished, and light emission intensity of the light emitting device 11 corresponding to a region of the moon (optical waveguide unit 29) is strengthened. The above region is specified to be nearly the same as the region sandwiched by the groove 31.

Explanation will be given in detail on function of the relevant groove 31, in the case where this groove 31 is a groove having an air layer. The emitted light from the light emitting device 11 is injected from the light incidence surface 21 of the optical waveguide 2 (the optical waveguide unit 29), and emitted from the light emitting surface 22, via the inside of the optical waveguide unit 29, and goes in a direction of the liquid crystal panel 5. In a process of reaching from the light emitting device 11 to the light emitting surface 22 of the optical waveguide unit 29, a part of light reaches the groove 31. Light reached the groove 31 is divided into light progressing from the inside of the optical waveguide unit 29 and passing through the groove 31 toward the air layer, and light for total internal reflection by the interface with the air layer of the groove 31. Among light injected to the groove 31, a most part of the light reflected totally here does not reach a region adjacent to the light emitting surface 22 partitioned by the groove 31, and follows the optical path of direction returning to the light emitting element 11 side. That is, the groove 31 has effect to partially suppress for light emitted from the light emitting device 11 corresponding to a certain optical waveguide unit 29 to go toward a different region partitioned by the groove 31.

On the other hand, because light emitted to the air layer by refraction goes linearly toward the direction of the liquid crystal panel 5, it is irradiated at an adjacent region partitioned by the groove 31.

In this way, by adjusting suitably the light reaching the groove 31 in ratio of light amount to be subjected to total internal reflection and light amount to be subjected to refraction, it is also possible to adjust a blurring method for an irradiation object of a target. This adjustment depends on shape of the groove 31. For example, by setting, as appropriate, width and/or depth of the groove 31, ratio of light amount to be subjected to total internal reflection and light amount to be subjected to refraction can be adjusted. For example, the deeper depth of the groove 31 provides the higher light amount to be subjected to total internal reflection, and thus light amount going from a certain optical waveguide unit 29 toward other optical waveguide unit 29, in other words, leak amount of light, can be suppressed the more.

As described above, in the present embodiment, light amount going from a certain optical waveguide unit 29 toward other optical waveguide unit 29 (leak amount of light) can be suppressed, and control of brightness by each region, corresponding to the above image content, can be made easy. As a result, it becomes possible to make compact sizing of algorism or to simplify calculation for determination of a light emission state of the light emitting device 11 in matching with a image signal, and development of a system for control of light emission of the light emitting device 11 in matching with a image signal becomes easy, by which a back light unit with high contrast and high quality, and the liquid crystal panel 2 using the same can be provided in low cost.

It should be noted that, in the present embodiment, as the light regulation unit 31, the light regulation unit (groove) 311 which is parallel to the direction D1, and the light regulation unit 312 which is parallel to the direction D2, are installed, however, either one of them may be used. In the light regulation unit 311, because formation direction thereof is vertical against a light emission direction of the light emitting device 11, suppression effect of leak amount of light against the D2 direction, that is, a light emission direction from the light emitting device 11, is large. Therefore, in the case of high directivity (light emission peak is steep) of the light emitting device 11, only the light regulation unit 311 may be installed. In addition, also the number of the light regulation unit should not be limited to the embodiment shown in FIG. 10, and is set in response to size of the liquid crystal panel 5 or fineness of brightness control by each region. For example, in the case where finer control is desired, the number of the light regulation unit will increase.

In addition, as shown in FIG. 10, by installment of both of the light regulation units 311 and 312, the light emitting surface 22 can be divided two-dimensionally, and still more, it becomes possible to adjust, as appropriate, aspect ratio of shape of the light emitting surface 22 obtained by division at the light regulation units 311 and 312. For example, in the case where the optical waveguide 2, which configures a back light unit to be used in a liquid crystal TV with the aspect ratio of 16:9, is divided at the light regulation units 311 and 312, by division of a longitudinal direction of the optical waveguide 2 into sixteen, and a shorter direction into nine, 1:1 square shape is provided, as shape of the light emitting surface 22 divided. In this way, by adjustment of aspect ratio of the divided region, it becomes possible to decrease scale of algorism for controlling a light emission state of the light emitting device 11 from an image signal. This is caused by the fact that the minimum region of the controllable back light unit depends on shape of the divided light emitting surface 22 of the optical waveguide 2.

In addition, still more, the light regulation unit 31 may be installed not at the light emitting surface 22 but at the bottom face 23. In this case, similarly as in the above, either one of the light regulation units 311 and 312, or both of them may be installed. In addition, the light regulation unit 31 may be installed at both of the light emitting surface 22 and the bottom face 23 of the optical waveguide 2. By installment of the light regulation unit 31 at the bottom face 23 of the optical waveguide 2, light after total internal reflection at the light regulation unit 31 of the bottom face 23 is diffused till reaching the light emitting surface 22 in the inside of the optical waveguide unit 29, and thus generation of luminance non-uniformity can be suppressed. Therefore, by installment of the light regulation unit 31 at bottom face 23 of the optical waveguide 2, light leak from a certain optical waveguide unit 29 to other optical waveguide unit 29 can be suppressed, as well as luminance non-uniformity generated by installment of the light regulation unit 31 can be reduced.

In the above embodiment, explanation was given on an embodiment of a groove having an air layer, as an example of the light regulation unit 31, however, it may not be a groove as long as it has similar function. For example, a linear concave part may be installed at the light emitting surface 22 or the bottom face 23 of the optical waveguide 2, so as to fill this concave part with a resin material having refractive index different from a material of the optical waveguide 2. A configuration of the light regulation unit 31 by a groove, as in the present embodiment, enables to attain simplification of a mold in one-piece molding of the optical waveguide, therefore it is also possible to reduce manufacturing cost of the mold. In addition, a diffusion face may be installed inside the groove, and a reflecting face after mirror fabrication may be installed, if necessary, or a light absorption means may be installed. In addition, they may be installed in combination.

### Embodiment 7

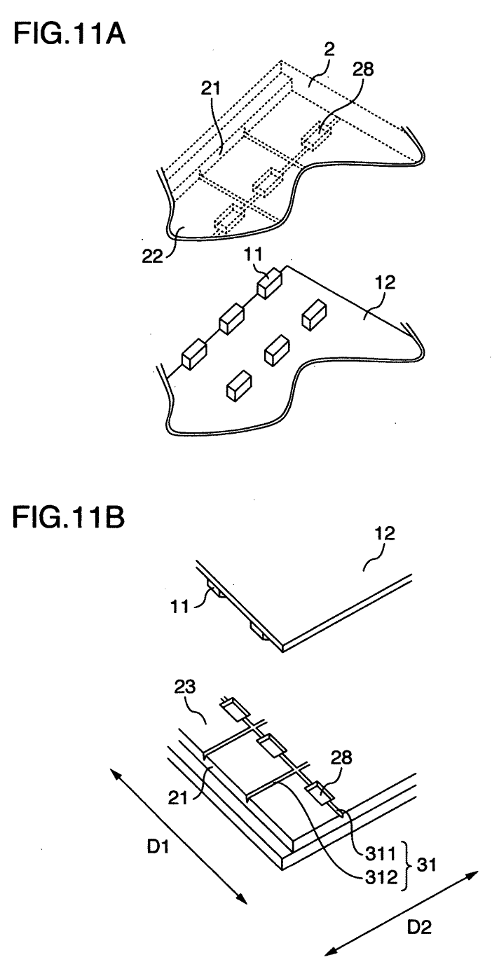

Explanation will be given on a seventh embodiment of the present invention with reference to FIGS. 11A and 11B. FIG. 11 shows a perspective view of the optical waveguide 2 relevant to the seventh embodiment of the present invention, FIG. 11A is a drawing of the relevant optical waveguide 2 viewed from the light emitting surface 22;, and FIG. 11B is a drawing of the relevant optical waveguide 2 viewed from the bottom face (reflecting face) 23.

As shown in FIG. 11, in the present embodiment, the grooves 311 and 312 are formed at the bottom face of the optical waveguide 2, as the light regulation unit 31, as well as a plurality of the rectangular shaped concave parts 28 are installed, which are connected to the groove 311 and have wider width and deeper depth than the relevant groove 311. This concave part 28 is one for storage of one or a plurality of light emitting devices 11, and hereafter shall be referred to as a light source storing unit. It should be noted that, the concave part 28 shall not penetrate the optical waveguide 2. In addition, the bottom face (reflecting face) 23 of the optical waveguide 2 is nearly parallel to the face of the substrate 12, and on the substrate 12, the light emitting device 11 is mounted, at the position corresponding to the light source storing unit 28.

In the present embodiment, because the optical waveguide 2 has the light source storing unit 28, it is possible to combine the light emitting device 11 without increasing the thickness of the optical waveguide 2, therefore, a back light unit with thin thickness can be provided. In addition, because the light source storing unit 28 is connected to the groove 311, light from a certain light emitting device 11 is limited by the groove 311 which is at the nearly the same position as the light emitting device 11 adjacent to a travelling direction of the light. Therefore, the minimum unit for controlling the light can be made nearly the same as an interval between a certain light emitting device 11 and the light emitting device 11 adjacent to a travelling direction of light from the relevant light emitting device 11. Therefore, according to the present embodiment, it is possible to arrange or set a light controllable region without spatial excess or deficiency, in the front face (light emitting surface) of the back light unit.

In addition, because the light source storing unit 28 does not penetrate the optical waveguide 2, crack or fracture can be prevented without decreasing strength of the optical waveguide 2. In addition, although not shown, a dowel or a hole, still more a claw or a screw mechanism, for positioning of both, may be installed at the substrate 12 and the optical waveguide 2. In addition, the light incidence surface 21 installed at the optical waveguide 2 may have a fine pattern structure.

In addition, in the present embodiment, both of the grooves 311 and 312 are installed as the light regulation unit 31, however, only either one of them may be installed.

In addition, at the light source storing unit 28, a light distribution adjustment element not shown may be installed. This light distribution adjustment element is installed, for example, by printing using ink having optical characteristics such as reflection, transmission, diffusion. Alternatively, the light distribution adjustment element may be configured by a fine pattern such as a groove, lens, or an optical sheet having the above optical characteristics may be arranged. In this way, by installment of the light distribution adjustment element at the light source storing unit 28, it is possible to control light distribution at the vicinity of the light emitting device 11, which is stored in the relevant light source storing unit 28 by the light distribution adjustment element, and thus a back light unit with good brightness uniformity can be provided.

### Embodiment 8

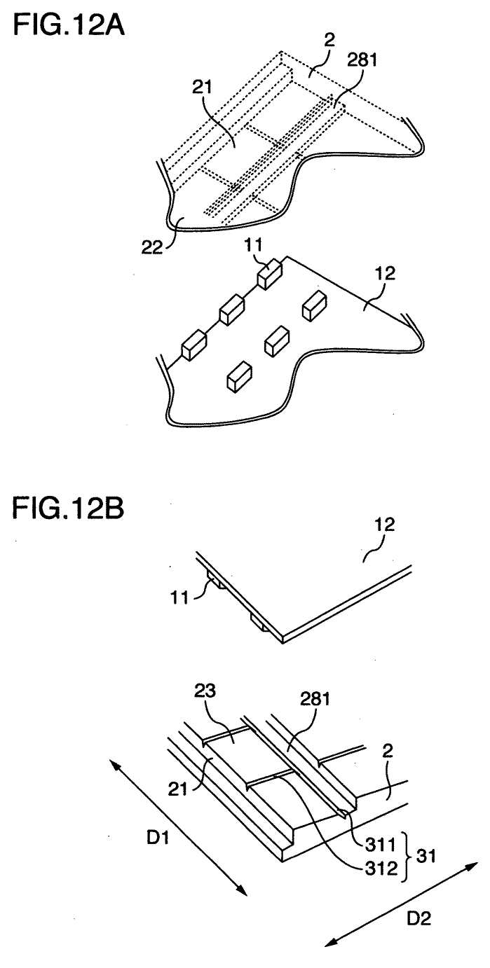

Explanation will be given on an eighth embodiment of the present invention with reference to FIGS. 12A and 12B. In this eighth embodiment also, similarly as in the seventh embodiment, both of the grooves 311 and 312 as the light regulation unit 31, and the light source storing unit are installed at the bottom face (reflecting face) of the optical waveguide 2, however, in the present embodiment, the light source storing unit 28 in the seventh embodiment is used as the groove-shaped light source storing unit 281 with groove shape extending along the direction D1 (that is, an arrangement direction of the light emitting device 11). At the opposite end part from a light travellinging direction of the light emitting device 11 of this groove-shaped light source storing unit 281 with groove shape, the groove 311 is formed as the light regulation unit 31. In the case where the groove-shaped light source storing unit 281 with groove shape has function of the light regulation unit by itself, this groove 311 may not be installed. In addition, the groove-shaped light source storing unit 281 with groove shape is communicated with space inside the back light unit.

In a configuration of the present embodiment, by exhausting heat generating in light emission by the light emitting device 11 through the groove-shaped light source storing unit 281 with groove shape, increase in temperature of the light emitting device 11 can be reduced, and decrease in light emission efficiency can be prevented. Heat exhaustion may be performed, for example, by forced cooling by using a fan or the like, although not shown, however, by extension of the groove-shaped light source storing unit 281 with groove shape in parallel to the vertical direction of the display panel 5, heat exhaustion may be attained by flowing external air from the lower part to the upper part of the groove-shaped light source storing unit 281 with groove shape, by utilization of convection. In addition, in the present embodiment, the reflecting face 23 is inclined against the face of the chassis 3, however, it may be parallel to the face of the chassis 3.

In addition, still more, by making the light source storing unit to groove shape as shown in FIG. 12, not only an LED but also a fluorescent lamp (CCFL, HCFL) can be used as the light source.

### Embodiment 9

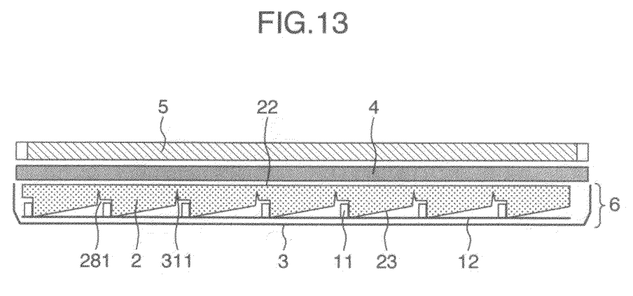

Explanation will be given on a ninth embodiment of the present invention with reference to FIG. 13. The present embodiment is one that incorporated, for example, the optical waveguide 2 shown in the eighth embodiment to the liquid crystal display apparatus 2, and is one that installed the optical sheet 4 having the function to adjust light distribution between the relevant optical waveguide 2 and the liquid crystal panel 5. In this way, bias of light distribution on the light emitting surface 22, which is caused by installment of the groove 311 as the light regulation unit, can be decreased. Such light distribution characteristics can be given, for example, by providing fine pattern printing with ink having the diffusion characteristics to the optical sheet 4, or by installment of a 1-dimensionally or 2-dimensionally periodic fine prism or a lens structure thereto. In addition, as the optical sheet 4, a diffusion sheet having the different haze depending on position may be utilized. In addition, a diffusion plate may be installed at the face of the liquid crystal panel 5 side of the optical sheet 4, or the face at the opposite side, or the face at both thereof. Light distribution characteristics of this diffusion plate can be given by providing the fine pattern printing with ink having, for example, the diffusion characteristics to the diffusion plate, or by installment of a 1-dimensionally or 2-dimensionally periodic fine prism or a lens structure thereto.

In addition, by a configuration to hold the optical sheet 4 by the liquid crystal panel 5 or other optical sheet, holding parts for the optical sheet 4 can be reduced, and thus a low price back light unit having small number of the parts and small number of assembly steps, and reduced production cost can be provided.

In addition, still more, as shown in FIG. 13, by installment of the groove 311, as the light regulation unit, at the bottom face 23 (reflecting face) of the optical waveguide 2, as described above, light having a progressing route changed by the groove 311 at the bottom face side, diffuses inside the optical waveguide 2, before reaching the light emitting surface 22 of the optical waveguide 2, therefore luminance non-uniformity on the light emitting surface 22 is reduced. Therefore, as shown in FIG. 13, luminance non-uniformity becomes small, for example, as compared with FIG. 1, even when the optical sheet 4 and the optical waveguide 2, and the optical sheet 4 and the liquid crystal panel 5 are mutually moved closer. Therefore, according to the present embodiment, an image display apparatus having small luminance non-uniformity and high quality can be provided, even when the image display apparatus is made thin.

It should be noted that, in an embodiment shown in FIG. 13, the optical waveguide 2 of FIG. 12 was used, however, it is natural that the optical waveguide 2 of FIG. 11 may be used.

In embodiments of the present invention explained above, the light emitting device 11 was mounted at the substrate 12, however, a driver circuit for driving the light emitting device may also be mounted therewith. In addition, the substrate 12 where the light emitting device 11 is mounted, was set only one sheet, however, it is not limited thereto, and a plurality of substrates may be used. In this way, response is possible by changing the number of the substrates in producing a back light unit with different size. That is, it is possible to utilize a common substrate 12, and thus it is advantageous in making the size development easy in the case where a plurality of substrates 12 is used, each substrate may have rectangle shape, and a longitudinal direction of this substrate may be arranged in response to a longitudinal direction of the back light unit, or may be arranged in response to a shorter direction of the back light unit. In addition, a plurality of substrates may be arranged two-dimensionally. In addition, still more, in the case where a plurality of substrates 12 are used, a relay substrate may be installed for relaying the control signals of power supplied from a power source circuit to each of the substrates, or a light source supplied from the signal circuit to each of the substrates.

In addition, in each of the embodiments, a color mixing element may be provided for mixing the light from the light emitting devices of three colors of RGB, or three colors of RGB and other colors (for example, yellow color and white color).

By light emission of color other than red, blue and green, by color of the light source 1, color reproduction is extended, and a back light unit with superior color reproduction can be provided. Because light beams themselves of different colors are mixed inside the integrated optical waveguide 2 having one sheet of the optical waveguide 2, it has advantage that visual confirmation of color unevenness and luminance non-uniformity is difficult at the light emitting surface 23, however, by installment of the color mixing element at the back light unit, color unevenness and luminance non-uniformity can be reduced still more. Such a color mixing element may be installed at the light source. For example, it can be attained by installment of a diffusion means, a lens, a fine prism structure or the like in front of the light source 1. Alternatively, the color mixing element may be installed at the optical waveguide 2. For example, at the light incidence surface 21 of the optical waveguide 2, any of the diffusion means, the lens, the fine prism structure, printing and the like may be used. In this way, a back light unit having color unevenness and luminance non-uniformity suppressed can be provided.

In this way, in an image display apparatus relevant to the present embodiment, it is possible to perform good control of brightness of the light source 1 in response to an image signal input, and local control of brightness of the back light unit. Therefore, by suppression of brightness of the back light unit at a dark area in image, and by performing of tone expression by the liquid crystal panel 5 for dark irradiation light, expression of the dark area can be enhanced, and leaking light from the liquid crystal panel 5 can be suppressed, by which light leakage can be prevented and contrast can be increased. Still more, because of suppression of charging power to the light source 1 corresponding to the dark area, it is possible to attain energy saving of the back light unit.

According to the above configuration, there can be provided a thin-type back light unit which makes possible large-sizing, improvement of heat radiation and weight saving, and is capable of attaining high contrast and energy saving, and having high brightness uniformity and easy production, and an image display apparatus using the same.

In addition, still more, according to the above present embodiment, there can be provided a back light unit which compensates demerits of the side-light system and the direct backlight, and is advantageous in thinning and low cost production, and improves quality and performance of illuminance control of the light source, and still more enhances also heat radiation performance of the light source, and a image display apparatus using the same.

Explanation was given in the above embodiments on a transmission-type liquid crystal panel as an example, however, it is applicable also to other display devices as long as they are passive-type display devices. The number of the above light source unit or the number of the optical waveguide and light source are determined, as appropriate, depending on size of a screen of an image display apparatus to which they are applied, and should not be limited to numerical values of the above embodiments.

As above, explanation was given on embodiments of the present invention, however, they are only one embodiment of the present invention, and the present invention should not be limited to these embodiments. It is natural that the present invention can be modified variously within a range not departing from the gist of the present invention, by those having ordinary knowledge in the technical field, to which the present invention belongs.

1. A display apparatus provided with a liquid crystal panel and a back light unit for irradiating a light onto said liquid crystal panel,
wherein the back light unit comprises a light source unit having in combination with a light source for emitting a light, and an optical waveguide having translucency to guide a light of said light source in a direction of the liquid crystal panel, and a chassis for holding or supporting said light source unit,
the optical waveguide is formed plate-like, as well as one side thereof is used as a light incidence surface where a light from the light source is injected, and
the light source unit is arranged in multiple in a horizontal direction or a vertical direction of the liquid crystal panel, in the back face side of the liquid crystal panel.

2. The display apparatus according to claim 1, wherein, in the optical waveguide, a face opposing to the back face of the liquid crystal panel is used as a light emitting surface, and a face opposing to the chassis is used as a reflecting face for reflecting a light, and the light emitting surface and one of a plurality of side faces adjacent to the reflecting face are used as the light incidence surface.

3. The display apparatus according to claim 2, wherein a plurality of the light source units are arranged, so that the optical waveguide of one of the light source units, and the light source of the other light source unit overlap, in a direction orthogonal to the display face of the liquid crystal panel.

4. The display apparatus according to claim 3, wherein the light source of the other light source unit is positioned at the back face side of the reflecting face of the optical waveguide in one of the light source units.

5. The display apparatus according to claim 3, wherein thickness of the optical waveguide gradually decreases from the light incidence surface of said optical waveguide toward the side face opposing to said light incidence surface.

6. The display apparatus according to claim 1, wherein at least two of a plurality of the light source units are connected together and are integrated.

7. A back light unit for irradiating a light onto a liquid crystal panel,
wherein the back light unit comprises a light source unit having in combination with a light source for emitting a light, and an optical waveguide having translucency to guide a light of said light source in a direction of the liquid crystal panel, and a chassis for holding or supporting said light source unit,
the optical waveguide is formed plate-like, and also, a face opposing to the back face of the liquid crystal panel is used as the light emitting surface for emitting a light, and a face opposing to the chassis is used as a reflecting face for reflecting a light, and one of a plurality of side faces adjacent to the light emitting surface and the reflecting face is used as a light incidence surface where a light from the light source is injected, and
a plurality of the light source units are arranged so that the light source of the other light source unit is positioned at the chassis side of the reflecting face of the optical waveguide in one of the light source units.

8. The back light unit according to claim 7, wherein the light emitting surfaces of a plurality of the optical waveguides are respectively arranged on nearly the same plane.

9. The back light unit according to claim 7, wherein the reflecting face of the optical waveguide is inclined against the light emitting surface or the main plane of the chassis.

10. The back light unit according to claim 9, wherein the reflecting face at the vicinity of the light incidence surface of the optical waveguide is nearly parallel to the main plane of the chassis.

11. The back light unit according to claim 7, wherein a part of the light incidence surface of the optical waveguide is nearly parallel to the reflecting face.

12. The back light unit according to claim 7, wherein a step is formed at the vicinity of the one side face of the optical waveguide.

13. The back light unit according to claim 7, wherein at least two of the light source units are connected and integrated.

14. The back light unit according to claim 13, wherein a step is formed at the light emitting surface at the vicinity of the light source of the optical waveguide.

15. A back light unit for irradiating a light onto a liquid crystal panel,
wherein the back light unit comprises a light source unit having in combination with a light source for emitting a light, and an optical waveguide having translucency to guide a light of said light source in a direction of the liquid crystal panel, and a chassis for holding or supporting said light source unit, the optical waveguide is formed plate-like, as well as, a face opposing to the back face of the liquid crystal panel is used as a light emitting surface for emitting a light, and said light emitting surface is formed in nearly a plane, and a bottom face opposing to the chassis is used as a reflecting face for reflecting a light, and one of a plurality of side faces adjacent to the light emitting surface and the reflecting face is used as a light incidence surface where a light from the light source is injected,
a plurality of the light source units are arranged so that the light source of the other light source unit is positioned at the chassis side of the reflecting face of the optical waveguide in one of the light source units, and
a plurality of the optical waveguides are one-piece molded, and at the light emitting surface or the bottom face of said one-piece molded optical waveguide, a light regulation unit is installed, which unit is one for determining boundary of the light source unit, and also for limiting a light from the optical waveguide of a certain light source unit toward the optical waveguide of other light source unit.

16. The back light unit according to claim 15, wherein the light regulation unit is a groove.

17. The back light unit according to claim 15, wherein a light source storage unit, where the light source is stored, is formed at the bottom face of the one-piece molded optical waveguide.

18. The back light unit according to claim 15, wherein a direction having a light emission peak of the light source is nearly parallel to the face of the chassis, and the light regulation unit is formed at least in a direction orthogonal to a direction having the light emission peak of the light source.
